(19) United States
(12) Patent Application Publication
(10) Pub. No.: US 2016/0268881 A1
(43) Pub. Date: Sep. 15, 2016

(54) Devices and Methods of Producing Electrical Energy for Measure While Drilling Systems

(71) Applicant: Rene Rey, Georgetown, TX (US)

(72) Inventor: Rene Rey, Georgetown, TX (US)

(21) Appl. No.: 15/069,606

(22) Filed: Mar. 14, 2016

Related U.S. Application Data
(60) Provisional application No. 62/132,532, filed on Mar. 13, 2015.

(51) Int. Cl. H02K 35/02; H02J 7/00; H02K 11/04; E21B 47/00; G01V 99/00

(52) U.S. Cl. CPC H02K 35/02; E21B 47/00; G01V 99/00; H02K 11/046; H02J 7/0068

(57) ABSTRACT

Devices and methods for powering a Measure While Drilling (MWD) system, providing a reciprocating generator comprising a suspension and mass system, a pressure housing, a sliding armature having an axis of movement and mechanically coupled to the suspension and mass system and responding to mechanical shock and vibration energy experienced by the reciprocating generator from the environment, magnets mounted on the sliding armature, and a stator with coils positioned such that the magnets induce a voltage/current in one or more of the coils. The stator is held stationary with respect to the pressure housing while the sliding armature is coupled to the suspension and mass system. The reciprocating generator is positioned to place the sliding armature's axis of movement substantially coincident with a long axis of the MWD system such that shock/vibration energy occurring on the long axis results in motion of the sliding armature, thereby generating an electrical output.

### CROSS-REFERENCE TO RELATED APPLICATIONS

This application claims the priority, under 35 U.S.C. §119, of U.S. Provisional Patent Application Ser. No. 62/132,532, filed on Mar. 13, 2015, the entire disclosure of which is hereby incorporated herein by reference in its entirety.

### STATEMENT REGARDING FEDERALLY SPONSORED RESEARCH OR DEVELOPMENT

Not Applicable

### FIELD OF THE INVENTION

The present systems and methods lie in the field of drilling.

### BACKGROUND OF THE INVENTION

The Measure While Drilling (MWD) industry provides directional sensor information for the proper drilling and tracking of gas and oil wells, which must conform to specific profiles of inclination and azimuth at any given depth. These systems cannot be conveniently or reliably powered from the surface via cables, owing to the rotating drill pipe and the many sections that are added and subtracted during the drilling operation. Instead, MWD sensor and telemetry systems (mud pulse or electro-magnetic) are traditionally powered via lithium thionyl chloride primary cells. These are both hazardous and expensive, and they present significant logistics challenges to the user, both in obtaining, distributing and disposing of them. Currently, there is no rechargeable battery technology that can meet both the temperature requirements of up to 200° C. and the high energy density needed for long time and physical endurance down hole.

The typical MWD system for on-shore use is housed in relatively small diameter pressure housings (typically 1.875″ diameter (approximately 4.8 cm)) and are several feet in length. The typically available inside diameter is on the order of 1.5 inches (approximately 3.8 cm). This predisposes designs for any housed system that are small in diameter but may be relatively long, on the order of several feet. MWD systems are modular, with the sensor/processor comprising one module, the telemetry another, and the power system (traditionally two modules of lithium thionyl chloride primary battery), plus auxiliary interconnects and other functions comprising a basic MWD system. Some systems include geological sensors (i.e., natural gamma, formation resistivity) each comprising an additional module.

There is a need to eliminate the use of any hazardous battery chemistry.

### SUMMARY OF THE INVENTION

The systems and methods described herein produce electrical energy for MWD systems without the use of batteries to thereby overcome the hereinafore-mentioned disadvantages of the heretofore-known devices and methods of this general type.

The MWD system is located within a short (less than 30 feet) distance from the drill bit. The devices and methods described herein replace the need for batteries to power the MWD system by the use of the abundant mechanical kinetic energy that is present near the drill bit/mud motor assembly. The basic building blocks are:
a. a reciprocating electromagnetic generator/alternator that is configured so that mechanical motions that manifest in the high shock and vibration levels found in the drilling environment actuate the generator and produce an electrical output;
b. the use of a rectifier system because the output of the generator is AC;
c. smoothing and normalizing via suitable buck and/or boost switching mode power supply

(SMPS) functional blocks because the generator's rectified output is not constant;
d. storing the normalized electrical output in a temporary storage system to achieve a smooth flow, to provide short term higher currents during telemetry events, and to provide power to the sensors and process controller during times when the drilling is suspended (such as when connections are made and a new position survey is needed, per current industry protocol);
e. converting the stored energy to a suitable voltage for use by the MWD system; and
f. incorporating in the energy recovery system suitable supervisory circuitry to monitor, record, and/or report operations.

With the foregoing and other objects in view, there is provided an energy production device powering a Measure While Drilling (MWD) system having a long axis, comprising a reciprocating generator having a suspension and mass system, a pressure housing, a sliding armature mechanically coupled to the suspension and mass system, responding to mechanical shock and vibration energy experienced by the reciprocating generator from the environment, and having an axis of movement, a plurality of permanent magnets mounted on the sliding armature, and a stator comprising a plurality of coils positioned such that the plurality of magnets induce a voltage and current in one or more of the coils, whereby the stator is held stationary with respect to the pressure housing while the sliding armature is coupled to the suspension and mass system. The reciprocating generator is positioned to place the axis of movement of the sliding armature substantially coincident with the long axis of the MWD system such that shock and/or vibration energy occurring on the long axis results in motion of the sliding armature to thereby generate an electrical output.

In accordance with a mode of an exemplary embodiment thereof, the reciprocating generator is a permanent magnet, polyphase, linear alternator.

In accordance with another mode of an exemplary embodiment thereof, each of the plurality of permanent magnets is a magnetic density, high curie point permanent magnet, the curie point being in excess of 250° C.

In accordance with a further mode of an exemplary embodiment thereof, the device further comprises is at least one anchor, wherein the sliding armature is mechanically coupled to the suspension and mass system with the at least one anchor.

In accordance with an added mode of an exemplary embodiment thereof, the suspension and mass system has a Q value that does not require operation at resonance.

In accordance with an additional mode of an exemplary embodiment thereof, the generated electrical output has an average output voltage between 1 VAC and 50 VAC.

In accordance with yet another mode of an exemplary embodiment thereof, the average output voltage is approximately 10 VAC.

In accordance with yet a further mode of an exemplary embodiment thereof, the generated electrical output is in the form of an alternating current (AC).

In accordance with another mode of an exemplary embodiment thereof, the device further comprises a rectifier system, wherein each of the plurality of coils are connected to a respective rectifier of the rectifier system, and the rectifier system converts the alternating current (AC) of the generated electrical output into the form of a direct current (DC).

In accordance with a further mode of an exemplary embodiment thereof, each rectifier is at least one configuration from a group of configurations including a full wave bridge configuration, a center tapped full wave configuration, and a gate logic synchronous configuration.

In accordance with an added mode of an exemplary embodiment thereof, the device further comprises normalization circuitry that smoothes and normalizes the direct current (DC) output of the rectifier system and produces an output voltage having a higher voltage than the generated electrical output of the reciprocating generator.

In accordance with an additional mode of an exemplary embodiment thereof, the normalization circuitry comprises a converter block comprising one or more of a flyback converter, a single-ended primary-inductor converter, a buck/boost converter, one or more PWM components, and one or more power factor correction components.

In accordance with yet another mode of an exemplary embodiment thereof, the device further comprises a temporary storage system to buffer the output voltage produced by the normalization circuitry, wherein the temporary storage system comprises a cell charge equalization circuit and a multi-cell storage unit in series with the cell charge equalization circuit.

In accordance with yet a further mode of an exemplary embodiment thereof, the multi-cell storage unit comprises a high temperature and low power density rechargeable battery of safe chemistry.

In accordance with another mode of an exemplary embodiment thereof, the temporary storage system operates at a voltage between 50 VDC and 200 VDC.

In accordance with a further mode of an exemplary embodiment thereof, the device further comprises a voltage converter that receives an input voltage from the temporary storage system and produces an output voltage having a voltage level sufficient to power a MWD system.

In accordance with an additional mode of an exemplary embodiment thereof, the voltage converter comprises one of a step down pulse width modulated switching mode power supply system and a buck regulator switching mode power supply.

In accordance with yet another mode of an exemplary embodiment thereof, the device further comprises a supervisory system that monitors and records data pertaining to the operation of one or more of the reciprocating generator, the rectifier system, the normalization circuitry, the multi-cell storage unit of the temporary storage system, the cell charge equalization circuit of the temporary storage system, and the voltage converter.

With the foregoing and other objects in view, there is also provided a drill powering device, which comprises a Measure While Drilling (MWD) system having a long axis and a reciprocating generator connected to the MWD system. The reciprocating generator comprises a suspension and mass system, a pressure housing, a sliding armature mechanically coupled to the suspension and mass system, responding to mechanical shock and vibration energy experienced by the reciprocating generator from the environment, and having an axis of movement, a plurality of permanent magnets mounted on the sliding armature, and a stator comprising a plurality of coils positioned such that the plurality of magnets induce a voltage and current in one or more of the coils, whereby the stator is held stationary with respect to the pressure housing while the sliding armature is coupled to the suspension and mass system, wherein the reciprocating generator is positioned to place the axis of movement of the sliding armature substantially coincident with the long axis of the MWD system such that shock and/or vibration energy occurring on the long axis results in motion of the sliding armature to thereby generate an electrical output.

With the foregoing and other objects in view, there is further provided a method for producing energy to power a Measure While Drilling (MWD) system, wherein the method comprises connecting a reciprocating generator to a drill of an MWD system, the reciprocating generator comprising a suspension and mass system, a pressure housing, a sliding armature having a plurality of permanent magnets and an axis of movement and being coupled to the suspension and mass system, a stator having coils and being held stationary with respect to the pressure housing, mechanically coupling the sliding armature to the suspension mass system to have the sliding armature respond to mechanical shock and vibration energy in proximity thereto by sliding, positioning the coils of the stator such that the plurality of magnets induce a voltage and current in each coil, and orienting the sliding armature such that the axis of movement coincides with the long axis of a MWD system to have any shock and/or vibration energy that occurs on the long axis of the MWD system result in motion of the sliding armature to thereby generate an electrical output.

Although the systems and methods taught herein are illustrated and described as embodied in devices and methods that produce electrical energy for MWD systems without the use of lithium thionyl chloride batteries, it is, nevertheless, not intended to be limited to the details shown as various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems and methods.

Additional advantages and other features that are characteristic of the systems and methods are set forth in the detailed description that follows and may be apparent from the detailed description or may be learned by practice of exemplary embodiments. Other features considered as characteristic for the systems and methods are also set forth in the appended claims. Still other advantages of the systems and methods may be realized by any of the instrumentalities, methods, or combinations particularly pointed out in the claims.

Accordingly, detailed embodiments of the systems and methods are disclosed herein; however, it is to be understood that the disclosed embodiments are merely exemplary of the systems and methods, which can be embodied in various forms. Therefore, the specific structural and functional details disclosed are not to be interpreted as limiting, but merely as a basis for the claims and as a representative basis for teaching one of ordinary skill in the art to variously employ the systems and methods in virtually any appropriately detailed structure. Furthermore, the terms and phrases used herein are not intended to be limiting; but rather, to provide an understandable description of the systems and methods. While the specification concludes with claims defining the systems and methods of the invention that are regarded as novel, the systems and methods will be better understood from the following description in conjunction with the drawing figures in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems and methods. Advantages of embodiments of the systems and methods will be apparent from the following detailed description of the exemplary embodiments thereof, which should be considered in conjunction with the accompanying drawings in which:

FIG. 1 is a fragmentary diagram of an exemplary embodiment of a generator component of an MWD energy producing system;

FIGS. 2A to 2C show an exemplary embodiment of a set of circuit diagrams of a rectifier component of the MWD energy producing system;

FIG. 3 is a block circuit diagram of an exemplary embodiment of a normalizing component of the MWD energy producing system;

FIG. 4 is a block circuit diagram of an exemplary embodiment of a storage component of the MWD energy producing system;

FIG. 5 is a block circuit diagram of an exemplary embodiment of a converter component of the MWD energy producing system; and

FIG. 6 is a block circuit diagram of an exemplary embodiment of a monitoring component of the MWD energy producing system.

### DETAILED DESCRIPTION OF THE INVENTION

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents. Alternate embodiments may be devised without departing from the spirit or the scope of the invention.

Before the systems and methods are disclosed and described below, it should be understood that the purpose of the terminology that is used herein is to describe particular embodiments only and is not intended to be limiting. For example, the terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises [ . . . ] a” does not, without more constraints, preclude the existence of additional identical elements in the process, method, article, or apparatus that comprises the element. The terms “including” and/or “having,” as used herein, are defined as “comprising” (i.e., open language). The terms “a” or “an”, as used herein, are defined as one, or, more than one. In addition, the term “plurality,” as used herein, is defined as two, or, more than two. Also, the term “another,” as used herein, is defined as at least a second or more. Furthermore, the description may use the terms “embodiment” or “embodiments,” which may each refer to one embodiment, or, more of the same or different embodiments.

Additionally, the terms “coupled” and “connected,” along with their derivatives, may be used. It should be understood that these two terms are not intended as synonyms for each other. Rather, in particular embodiments, the term “connected” could be used to indicate that two or more elements are in direct physical or electrical contact with each other. Similarly, the term “coupled” may be used to indicate that two or more elements are in direct physical or electrical contact (e.g., directly coupled). However, “coupled” may also mean that two or more elements are not in direct contact with each other, but yet still cooperate or interact with each other (e.g., indirectly coupled).

Also, for purposes of the following description, a phrase in the form “A/B,” or in the form “A and/or B,” or in the form “at least one of A and B,” is intended to mean (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form, “at least one of A, B, and C,” is intended to mean (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up and down, back and front, and top and bottom. Such descriptions are used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

In addition, it will be appreciated that embodiments of the systems and methods described herein may be comprised of one or more conventional processors and unique stored program instructions that control the one or more processors to implement, in conjunction with certain non-processor circuits and other elements, some, most, or all of the functions of the powered injector devices described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

Generally, the terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Various embodiments of the systems and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

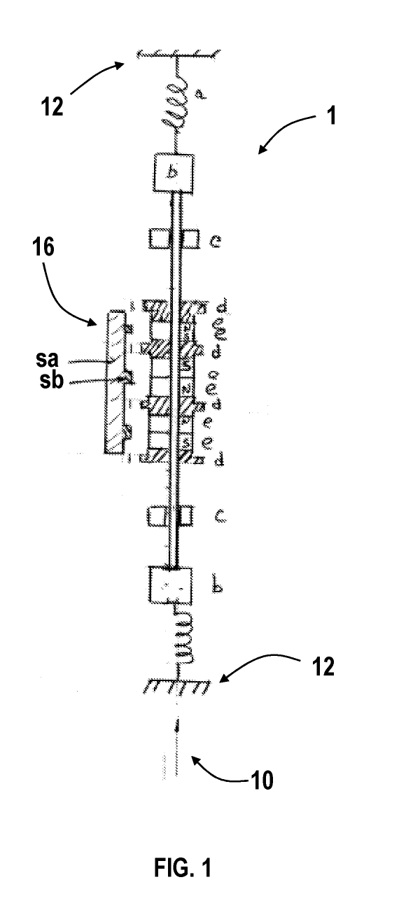

Described now are exemplary embodiments of the systems and methods herein. Referring now to the figures of the drawings in detail and first, particularly to FIG. 1, there is shown a first exemplary embodiment of a reciprocating generator 1 that is comprised of a permanent magnet, polyphase, linear alternator and/or, for example, a permanent electrostatic filed (electret) linear alternator. The generator or alternator has a plurality of suitable magnetic density, high curie point (in excess of 250° C.) permanent magnets e mounted on a sliding armature 10. In the case in which the generator 1 is comprised of an electret, the generator 1 consists of a plurality of suitable electret elements whose moving electrodes are coupled to the sliding armature 10. Using one or more anchors 12, the armature 10 is mechanically coupled to a suspension a and mass b system that responds to the mechanical shock and vibration energy present in the drilling environment.

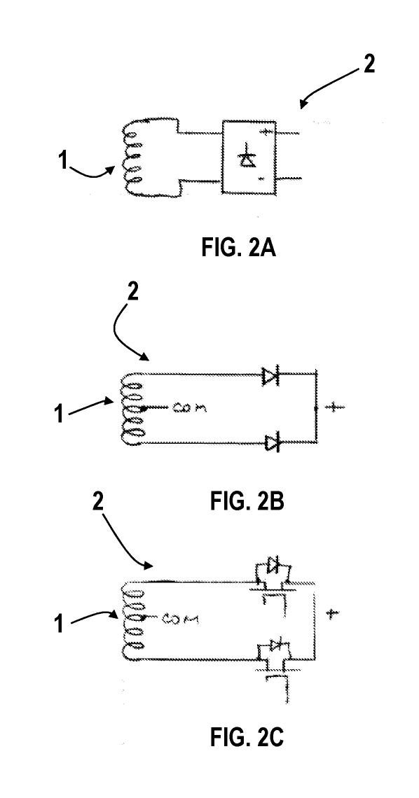

The stator 16 is comprised of a plurality of armature coils sa with dimensions and placement such that the reciprocating magnets e will induce a maximum voltage and current on each coil sa. In the case in which the generator 1 is comprised of an electret, the stator 16 is comprised of the stators of the electret elements. As described in further detail below with reference to FIGS. 2A-2C, the coils sa may be connected each to a rectifier or may be interconnected to achieve maximum output as a compound set. Likewise, in the case in which the generator 1 is comprised of an electret, the electret electrodes may be each connected to a suitable rectifier or may be interconnected to achieve maximum output.

The stator 16 is held stationary with respect to the pressure housing while the sliding armature 10 is coupled to the suspension system a, which, as mentioned above, includes a suitable mass system b. The armature suspension system also provides control of the radial movement of the armature to prevent damage and friction losses by providing close control under operation of the gap between the armature and the rotor. This gap is kept to a minimum in order to maximize generator efficiency in the conversion of armature motion to electricity.

The orientation of the generator 1 is such that its axis of movement (long axis) coincides with the MWD system's long axis. Thus, any shock and vibration energy that occurs on the long (Z) axis of the MWD tool string will result in motion of the sliding armature 10, thereby generating an electrical output.

The suspension system a, b is deliberately of low Q so operation at resonance is not required and will respond to the typical excitation frequency range of 2-200 Hz. An exemplary variant includes a mechanism, such as swash plates and suitable rolling masses, to translate radial mechanical input to axial motion, which then stimulates the generator 1 as described. The use of a radial energy recovery system may be used independently or in conjunction with the axial recovery system. The average output voltage of the generator 1 is typically approximately 10 VAC, but may be as low as 1 VAC and as high as 50 VAC. The output power is in the order of 10 W average, which is sufficient to maintain the typical MWD system's average power requirement. The volumetric power density of the reciprocating generator approaches 100 mW per cm³.

Alternatively, or concurrently, an electromagnetic generator, as already described, may be used to extract energy over convenient excitation frequencies, directions and amplitudes while the electret system compliments by extracting energy at other excitation frequencies, directions and amplitudes. Notably, but not exclusively, the electret system may be more effective at extracting low amplitude energy of a radial orientation while the electromagnetic system may be more effective with axial, high amplitude/high frequency energy input.

The output of each coil sa or phase or coil array of generator system 1 may be converted to DC using any suitable rectifier system 2 configuration, which are known in the electrical arts. To increase efficiency, the rectifier system 2 may be of the synchronous type, where diode action is enhanced by the use of a solid state switch (MOSFET and/or bipolar transistors) that is driven into saturation during conduction periods. FIGS. 2A to 2C illustrate several possible embodiments for rectifier system 2. These embodiments include, for example, the full wave bridge configuration depicted in FIG. 2A, the center tapped full wave rectifier configuration depicted in FIG. 2B, and the gate logic synchronous rectifier configuration that is depicted in FIG. 2C. Each of these possible embodiments may be separately utilized and implemented, or, the rectifier system 2 may be comprised of one or more of the embodiments together. The embodiments that are shown in FIGS. 2A to 2C are merely illustrative and are not intended to limit the possible configurations for the rectifier system 2.

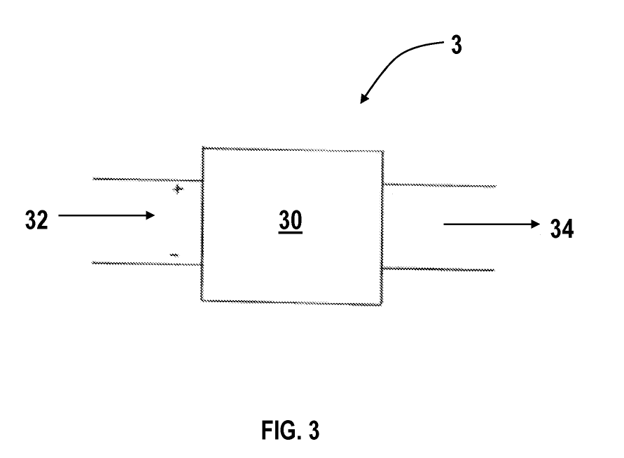

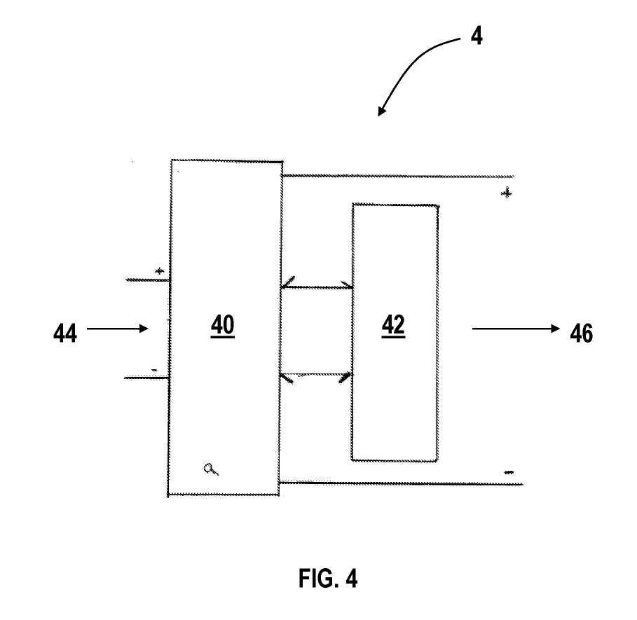

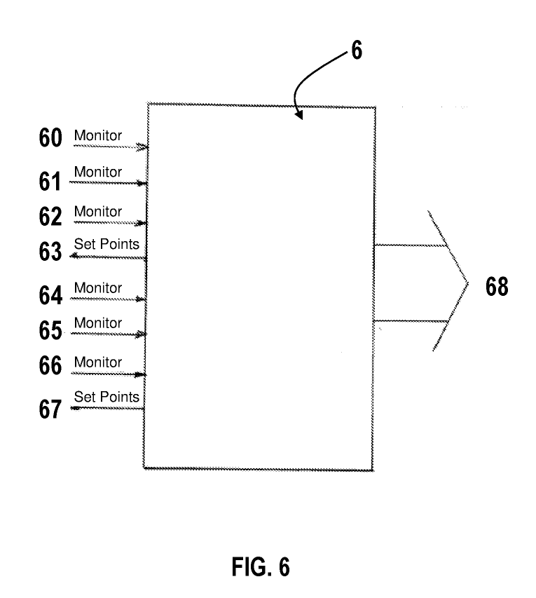

The fluctuating DC output from the generator 1/rectifier system 2 is smoothed and normalized to a constant level by the use of SMPS circuitry. The topology utilized will actively match the impedance of the generator in a dynamic manner to maximize the energy transfer and may utilize techniques similar to those used by off-line power supplies with power factor correction, which increase the conduction angle of the rectifying system 2. An exemplary embodiment of such a circuitry configuration is depicted in FIG. 3. This embodiment is for illustrative purposes only and is not intended to limit the number of possible circuit configurations of the SMPS circuitry 3. In this particular embodiment, a converter block 30 receives an input voltage 32 from rectifier system 2 and produces an output voltage 34 that is stored in a temporary storage system 4 (see, for example, the description of FIG. 4 below). The converter block 30 may be comprised of one or more of a flyback converter, a single-ended primary-inductor converter (SEPIC), a buck/boost converter, PWM component(s), and/or a power factor correction component(s). Additionally, the controls and logic utilized in the disclosed system may include, but are not limited to, low input voltage cut off, constant voltage and/or constant current charging, monitoring of outputs (see FIG. 6), and programmable set points.

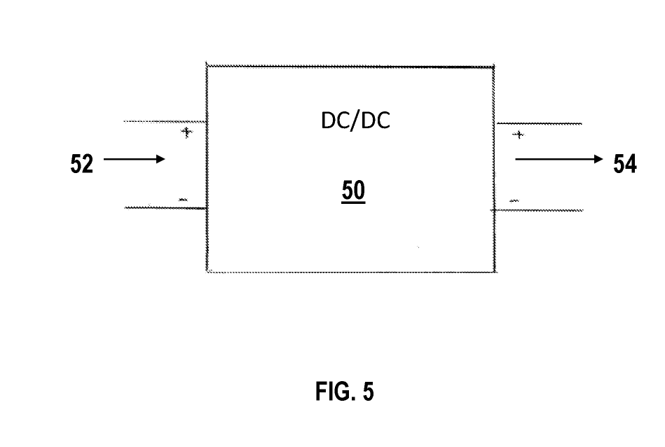

To reduce ripple and charging currents, to increase stored energy volumetric density in storage system 4, and to provide maximum energy extraction capability to a voltage converter (described in reference to FIG. 5 below), the output voltage 34 of the normalization circuitry 3 will be of a suitably higher voltage (for example, in the optimal range of 50-200 VDC) than that of the output of generator 1. The energy transfer efficiency from the rectifier system 2 to the SMPS circuitry 3 may be enhanced further by the use of one normalization circuit 3 per generator 1/rectifier 2 phase, coil or coil array implemented.

Turning to FIG. 4, the mechanical energy existing during drilling operations, while of high amplitude, is, by nature, neither constant nor consistent. Therefore, a temporary storage system 4 is devised to provide buffering of the generated current. In FIG. 4, there is depicted an exemplary embodiment of the temporary storage system 4, which is comprised of a multi cell storage unit 40 that is placed in series with a cell charge equalization circuit 42. The embodiment depicted in FIG. 4 is for illustrative purposes only and is not intended to limit the possible configurations of the temporary storage system. According to FIG. 4, the multi-cell storage unit 40 receives an input voltage 44 from normalization circuit 3 (i.e., output voltage 34) and outputs a voltage 46, from the cell charge equalization circuit 42, to the voltage converter. As mentioned above, the function of this temporary storage system 4 is to absorb the energy during generation peaks and to provide current to the load during input energy valleys. This temporary storage system 4 also provides energy to the sensor systems during intentional short intervals when drilling has been suspended so that an accurate position survey may be taken. The multi-cell storage unit 40 may be comprised of, but is not limited to, safe chemistry rechargeable battery cells, electrolytic double layer capacitors, and/or electrolytic capacitors. Accordingly, an inventive high temperature and low power density rechargeable battery is contemplated to be within the scope of the disclosed invention to be used for the purpose of powering the storage element(s) of the disclosed system.

Pursuant to the existing industry protocol, there is no telemetry during these times that translates to a lower level of energy needed for the survey than during drilling. The typical industry standard system requires about 2.5 W/S for up to ninety (90) seconds, at a nominal voltage of 24 VDC. To maximize volumetric efficiency, to keep peak currents low, and to provide adequate head room during discharge, the temporary storage system 4 will operate at voltage levels higher than either the generator output voltage (approximately 10 VAC) or the normal load voltage (nominally 25 VDC). Suitable levels range from 50 VDC to 200 VDC.

Thereafter, this conveniently high voltage level from temporary storage system 4 is converted to a voltage level that is suitable for the MWD system, i.e., a nominal 25 VDC, by a voltage converter. FIG. 5 depicts an exemplary embodiment of such a voltage converter 50, whereby the voltage converter 50 receives an input voltage 52 from the temporary storage system 4 (i.e., output voltage 46) and produces an output voltage 54 used to power the MWD system. This voltage converter 50 may comprise a step down pulse width modulated (PWM) switching mode power supply (SMPS) system, a buck regulator SMPS, or any SMPS topology variant. By starting from a high voltage from the temporary storage system 4, over 90% of energy recovery from the temporary storage system 4 is possible. This embodiment is for illustrative purposes only and is not intended to limit the possible configurations of voltage converter 50.

Further, the controls and logic utilized in the disclosed system may include, but are not limited to, monitoring of the output current and limit, under voltage (input) shutdown, monitoring of outputs (see FIG. 6), and programmable set points.

The overall status and operation of the above-described electrical energy production system is monitored and recorded by a supervisory system 6. The gathered data may be only recorded by nonvolatile memory of the supervisory system 6, or it may be both recorded and telemetered to the surface in real time. The supervisory system 6 may monitor a number of operations that include, but are not limited to, the operations of the generator 1, the rectifier system 2, the normalization circuit 3, the temporary storage system 4, the step down circuit 50, and the monitoring/recording system 6, in any combination deemed suitable for the particular installation. One exemplary embodiment of the supervisory system 6 is depicted in FIG. 6. In this particular embodiment, system 6 has a number of different inputs that include, but are limited to, a monitoring input 60 from the generator 1, a monitoring input 61 from the rectifier system 2, a monitoring input 62 from normalization circuit 3, a monitoring input 64 from the multi-cell storage unit 40 of the temporary storage system 4, a monitoring input 65 from the cell charge equalization circuit 42 of the temporary storage system 4, and a monitoring input 66 from the voltage converter 50. In addition, this particular embodiment of the supervisory system 6 outputs setpoints 63, 67 to the normalization circuit 3 and voltage converter 50, respectively. Any communication and/or control signals resulting from the received data and the analysis performed by the system 6 is output through one or more communication port(s) 68. Components of the supervisory system 6 may include, but are not limited to, a microprocessor, voltage/current signal digitizers, digital I/O, nonvolatile memory for data and setpoints, a real time clock (RTC) for date/time stamps of recorded data, and the one or more communication ports.

The foregoing description and accompanying drawings illustrate the principles, exemplary embodiments, and modes of operation of the systems and methods. However, the systems and methods should not be construed as being limited to the particular embodiments discussed above. The particular choice of embodiments for purposes of providing the description herein is not intended to limit a particular feature to being applicable to only the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that that feature cannot be associated or equated to another feature in another drawing figure or description. Additional variations of the embodiments described above and depicted in the drawings will be appreciated by those skilled in the art and the above-described embodiments should be regarded as being illustrative rather than restrictive. Accordingly, it should be appreciated that variations of those embodiments can be made by persons of skill in the art without departing from the scope and spirit of the systems and methods as defined by the following claims.

What is claimed is:

1. An energy production device powering a Measure While Drilling (MWD) system having a long axis, comprising:
a reciprocating generator having:
a suspension and mass system;
a pressure housing;
a sliding armature mechanically coupled to the suspension and mass system, responding to mechanical shock and vibration energy experienced by the reciprocating generator from the environment, and having an axis of movement;
a plurality of permanent magnets mounted on the sliding armature; and
a stator comprising a plurality of coils positioned such that the plurality of magnets induce a voltage and current in one or more of the coils, whereby the stator is held stationary with respect to the pressure housing while the sliding armature is coupled to the suspension and mass system,
the reciprocating generator being positioned to place the axis of movement of the sliding armature substantially coincident with the long axis of the MWD system such that shock and/or vibration energy occurring on the long axis results in motion of the sliding armature to thereby generate an electrical output.

2. The device according to claim 1, wherein the reciprocating generator is a permanent magnet, polyphase, linear alternator.

3. The device according to claim 1, wherein each of the plurality of permanent magnets is a magnetic density, high curie point permanent magnet, the curie point being in excess of 250° C.

4. The device according to claim 1, further comprising at least one anchor, the sliding armature being mechanically coupled to the suspension and mass system with the at least one anchor.

5. The device according to claim 1, wherein the suspension and mass system has a Q value that does not require operation at resonance.

6. The device according to claim 1, wherein the generated electrical output has an average output voltage between 1 VAC and 50 VAC.

7. The device according to claim 6, wherein the average output voltage is approximately 10 VAC.

8. The device according to claim 1, wherein the generated electrical output is in the form of an alternating current (AC).

9. The device according to claim 8, further comprising a rectifier system, each of the plurality of coils being connected to a respective rectifier of the rectifier system, and the rectifier system converting the alternating current (AC) of the generated electrical output into the form of a direct current (DC).

10. The device according to claim 9, wherein each rectifier is at least one configuration from a group of configurations including:
a full wave bridge configuration;
a center tapped full wave configuration; and
a gate logic synchronous configuration.

11. The device according to claim 9, further comprising normalization circuitry that smoothes and normalizes the direct current (DC) output of the rectifier system and produces an output voltage having a higher voltage than the generated electrical output of the reciprocating generator.

12. The device according to claim 11, wherein the normalization circuitry comprises a converter block comprising one or more of:
a flyback converter;
a single-ended primary-inductor converter;
a buck/boost converter;
one or more PWM components; and
one or more power factor correction components.

13. The device according to claim 11, further comprising a temporary storage system to buffer the output voltage produced by the normalization circuitry, the temporary storage system comprising a cell charge equalization circuit and a multi-cell storage unit in series with the cell charge equalization circuit.

14. The device according to claim 13, wherein the multi-cell storage unit comprises a high temperature and low power density rechargeable battery of safe chemistry.

15. The device according to claim 13, wherein the temporary storage system operates at a voltage between 50 VDC and 200 VDC.

16. The device according to claim 13, further comprising a voltage converter that receives an input voltage from the temporary storage system and produces an output voltage having a voltage level sufficient to power a MWD system.

17. The device according to claim 16, wherein the voltage converter comprises one of:
a step down pulse width modulated switching mode power supply system; and
a buck regulator switching mode power supply.

18. The device according to claim 16, further comprising a supervisory system that monitors and records data pertaining to the operation of one or more of:
the reciprocating generator;
the rectifier system;
the normalization circuitry;
the multi-cell storage unit of the temporary storage system;
the cell charge equalization circuit of the temporary storage system; and
the voltage converter.

19. A drill powering device, comprising:
a Measure While Drilling (MWD) system having a long axis; and
a reciprocating generator connected to the MWD system and having:
a suspension and mass system;
a pressure housing;
a sliding armature mechanically coupled to the suspension and mass system, responding to mechanical shock and vibration energy experienced by the reciprocating generator from the environment, and having an axis of movement;
a plurality of permanent magnets mounted on the sliding armature; and
a stator comprising a plurality of coils positioned such that the plurality of magnets induce a voltage and current in one or more of the coils, whereby the stator is held stationary with respect to the pressure housing while the sliding armature is coupled to the suspension and mass system,
the reciprocating generator being positioned to place the axis of movement of the sliding armature substantially coincident with the long axis of the MWD system such that shock and/or vibration energy occurring on the long axis results in motion of the sliding armature to thereby generate an electrical output.

20. A method for producing energy to power a Measure While Drilling (MWD) system, comprising:
connecting a reciprocating generator to a drill of an MWD system, the reciprocating generator comprising a suspension and mass system, a pressure housing, a sliding armature having a plurality of permanent magnets and an axis of movement and being coupled to the suspension and mass system, a stator having coils and being held stationary with respect to the pressure housing
mechanically coupling the sliding armature to the suspension mass system to have the sliding armature respond to mechanical shock and vibration energy in proximity thereto by sliding;
positioning the coils of the stator such that the plurality of magnets induce a voltage and current in each coil; and
orienting the sliding armature such that the axis of movement coincides with the long axis of a MWD system to have any shock and/or vibration energy that occurs on the long axis of the MWD system result in motion of the sliding armature to thereby generate an electrical output.
